(19) United States
(12) Patent Application Publication
(10) Pub. No.: US 2009/0004505 A1
(43) Pub. Date: Jan. 1, 2009

(54) Composition For Laminate Having Reduced Metal Content, System, And Method Of Making Thereof

(76) Inventor: Dennis Carespodi, Winston-Salem, NC (US)

Correspondence Address: KILPATRICK STOCKTON LLP, 1001 WEST FOURTH STREET, WINSTON-SALEM, NC, 27101, US

(21) Appl. No.: 12/122,198

(22) Filed: May 16, 2008

Related U.S. Application Data
(60) Provisional application No. 60/930,452, filed on May 16, 2007.

(51) Int. Cl. B21D 39/00; B32B 37/00

(52) U.S. Cl. 428/624; 428/621; 156/301

(57) ABSTRACT

A reduced-foil laminate, system, and method of making a reduced-foil laminate can include a non-metal core layer, a first outer metal layer, and a second outer metal layer having the first outer layer and second outer layer being laminated to the core layer on opposite sides of the core layer. The laminate can be symmetrical and asymmetrical. The laminate can be die-cuttable, and/or heat sealable. Embodiments of the laminate can remain substantially free from curling and may be readily denested during package processing.

### CROSS REFERENCE TO RELATED APPLICATIONS

The present application claims priority under 35 USC 119(e) from U.S. Provisional Patent Application No. 60/930,452, filed May 16, 2007, which is incorporated by reference herein in its entirety.

### FIELD OF THE INVENTION

The following description relates to compositions for laminates having reduced metal content, systems comprising laminates having reduced metal content, and methods of making laminates having a reduced metal content.

### BACKGROUND

Peelable lidding materials for containers can be useful in the food packaging art as peelable closures for plastic convenience food packaging. Conventionally, such lidding materials can include heavy gauge monolithic metal foils. The monolithic metal lids can be die-cuttable so as to be supplied or dispensed from a stack of lids in conventional food packaging machinery. Monolithic foil lidding materials typically used in such packaging applications comprise single aluminum foil layer having a minimum thickness of about 1.0 mil (0.0010 inch).

Such lids can be sealed to a container or sealed to form a pouch by applying a heat sealable coating or film to one side of the foil or to one side of a foil/film laminate. A conventional foil/film laminate can include a single foil layer, having a thickness of 1.25 mil, and a film layer having a thickness of 1.25 mil. For example, an individual lid can be placed on a container and heat sealed to the container using a packaging machine or by other methods known in the art. At foil thicknesses below about 1.0 mils, the foil material may not have adequate stiffness for feeding during the die cutting operation. Further, foil material having a foil thickness below 1.0 mil may not have a sufficient stiffness for denesting and dispensing of individual die-cut lids on the packaging machinery. Denesting refers to the separation of individual laminates or lids from a stack containing a plurality of lids. Additionally, such conventional foil material having a foil thickness below 1.0 mil may fracture during embossing processes.

Conventional lidding laminates that reduce or eliminate the aluminum content contained therein may sacrifice desired performance and mechanical properties as compared to a monolithic aluminum lid. For example, some conventional laminates with a reduced aluminum content may curl or bend. Curling is a property that measures the amount in which a laminate or lid deviates from lying completely flat. Curling of a laminate or lid from exposure to handling, dispensing, heat, or from stresses in the laminate that occur during the lamination process can be a problem with reduced-foil or non-foil containing laminates. Replacing aluminum foil in packaging processes and machines that use die-cut lidding can be difficult as the replacing material, for example plastic, typically may not have all of the desirable physical characteristics of aluminum foil.

A conventional film that has been used in some cases to replace the aluminum within a lid is a heavy gauge coextruded film consisting of polypropylene with an appropriate sealant layer for use as a lidding on a polypropylene container. Because the structure is a coextruded cast film, lamination is not required and curl generally does not occur. The polypropylene layer has a thickness of about 3.0 to 5.0 mils to provide stiffness and die cuttability. While such an approach using coextruded cast film can be used, it requires the capability of manufacturing coextruded cast films which many packaging operations may not have. Also, such a coextruded cast film may have a limited range in the amount of heat that can be used to seal the film to the container.

It would be desirable to provide a laminate material which is easily die-cuttable, readily denested, and/or sufficiently stiff for dispensing in a packaging machine. Further, it would be desirable to provide a laminate which minimizes or eliminates curl of the laminate when exposed to a hot-filled container or the heat of the heat seal mechanism of a packaging machine.

### SUMMARY OF THE INVENTION

Described herein are embodiments of a laminate comprising reduced metal content, systems comprising such laminates, and methods of making such laminates that can be useful in packaging applications. For example, laminates of the present invention may be applied to a container or used to create a pouch. In one embodiment, the metal used in the laminate can be a foil.

In some embodiments, the present invention may comprise a laminate comprising a non-metal core layer, a first outer layer comprising a metal, and a second outer layer comprising a metal. In one embodiment, the metal of the first outer layer and/or the second outer layer can be a foil. In one embodiment, the first outer layer and second outer layer can be laminated on opposites sides of the core layer.

In other embodiments, the present invention may comprise a system. The system may comprise a container and a laminate having a non-metal core layer, a first outer metal layer, and a second outer metal layer. In some embodiments, the metal of the first outer layer and/or second outer layer can be a foil. In some embodiments, the laminate can be die-cuttable. In some embodiments, the laminate can be die-cuttable to define a lid. In certain embodiments, the laminate can be heat sealable to the container. In some embodiments, the laminate can comprise a sealing layer positioned on one of the outer layers.

In yet other embodiments, the present invention may comprise a method for making a laminate. In certain embodiments, the method may comprise adhering a first layer and a second layer, each being comprised of a metal, to sides of a core layer comprising a non-metal material to form a laminate structure. The method may further comprise applying a sealing layer to the exterior surface of one of the outer layers. The first layer and second layer can be adhered to opposite sides of the core layer.

Features of a laminate having a reduced metal content, systems that use such laminates, and/or methods of making such laminates may be accomplished singularly, or in combination, in one or more of the embodiments. As will be realized by those of skill in the art, many different embodiments of a laminate having a reduced metal content, systems, and/or methods of making a laminate having a reduced metal content are possible. Additional uses, advantages, and features of the laminates, systems, and methods of the present invention are set forth in the illustrative embodiments discussed in the detailed description herein and will become more apparent to those skilled in the art upon examination of the following.

### BRIEF DESCRIPTION OF THE DRAWINGS

FIG. 1 is a cross-sectional view of one illustrative embodiment of the present invention showing a laminate structure having a symmetrical configuration.

FIG. 2 is a cross-sectional view of one illustrative embodiment of the present invention showing a laminate structure having an asymmetrical configuration.

FIG. 3 is a side elevation view of a container with a lid heat sealed to the container in accordance with one embodiment of the present invention.

FIG. 4 is a top plan view of the heat sealed container of FIG. 3 illustrating the heat sealed area of the lid in accordance with one embodiment of the present invention.

FIG. 5 is a cross-sectional view of an embodiment having a pouch defined by a heat sealed laminate structure in accordance with one embodiment of the present invention.

### DETAILED DESCRIPTION OF THE INVENTION

Described herein are embodiments of a laminate having a reduced metal content, systems comprising such laminates, and/or methods of making a laminate having a reduced metal content that can be useful in packaging applications such as applying a portion of the laminate to a container or creating a pouch from the laminate.

Thus, in one embodiment, the present invention may comprise a laminate comprising a non-metal core layer, a first outer layer comprising a metal, and a second outer layer comprising a metal. In some embodiments, the first outer layer and second outer layer can be laminated on opposite sides of the core layer.

In other embodiments, the present invention may comprise a system. The system may comprise a laminate that is attached (or attachable) to a container. In some embodiments, the system comprises a container. In some embodiments, the laminate may comprise a non-metal core layer, a first outer layer comprising a metal, and a second outer layer comprising a metal. In some embodiments, the first outer layer and/or second outer layer can be laminated on opposites sides of the core layer.

In yet other embodiments, the present invention may comprise a method of making a laminate. The method may comprise adhering a first metal layer and second metal layer to opposite sides of a core layer to generate a laminate comprising a core layer and first outer metal layer and second outer metal layer. The method may further comprise applying a sealing material to at least one of the outer layers to generate a sealing layer.

In some embodiments of the laminate, system, and method for making a laminate, the core layer may comprise a thickness in a range of about 0.5 mils to about 10.0 mils. In some embodiments, the first outer layer can comprise a thickness in a range of about 0.20 mils to about 1.0 mils. In some embodiments, the second outer layer can comprise a thickness in a range of about 0.20 mils to about 1.0 mils. In some embodiments, the first outer layer and the second outer layer can have substantially the same thickness. In other embodiments, the first outer layer and second outer layer can have different thicknesses. In some embodiments, the first outer layer and second outer layer each comprise a thickness to reduce and/or prevent curling of the laminate.

In some embodiments of the laminate, system, and method for making a laminate, the laminate can comprise a sealing layer that can be applied to one of the outer layers. In some embodiments, the laminate can be heat sealed to a container. In some embodiments, the laminate can be die-cuttable. In certain embodiments, the laminate can be die-cut into a lid. In other embodiments, the laminate can be used to define a pouch, for example, by sealing one portion of the laminate to a different portion of the laminate.

In some embodiments of the laminate, system, and method for making a laminate, the laminate can comprise a core layer comprising a void-bearing, opalescent, oriented polypropylene film. In some embodiments, the core layer can comprise a polypropylene core layer having a density in a range between about 0.4 g/cm³ to about 0.9 g/cm³. In other embodiments, the core layer can comprise cellulose.

In some embodiments of the laminate, system, and method for making a laminate, the laminate can comprise a first outer layer or a second outer layer that is embossable such that a texture is applied to the surface of the laminate. In embodiments where the first outer layer or second outer layer is embossed, a surface texture applied during embossing can facilitate separation of a plurality of laminates.

In some embodiments of the laminate, system, and method for making a laminate, the laminate can have a printable layer adhered to one of the outer layers. The printable layer can be adhered on the outer layer opposite the sealing layer.

Laminates that include layers comprising a metal such as a foil can have properties that may be beneficial in a packaging operation. Some of these properties include inherent stiffness, deadfold and lay-flat characteristics where the laminates may maintain a substantially planar orientation during various packaging operations, gas and moisture barrier properties reducing permeability of the laminate, thermal stability, static charge dissipation characteristics, and/or relatively low cost as compared to other materials that can be used in packaging operations. A large number of heat seal coatings, lacquers, extrusions, co-extrusions, and films have been developed for application to or lamination with aluminum foil to provide peelable heat seals to most plastic container materials, such as polypropylene, polyethylene, polystyrene, and polyester.

As the price of metals and their raw materials, such as aluminum ingot, increase, packaging laminates that contain metals based solely on monolithic aluminum foil have become increasingly more costly. Embodiments of the present invention can reduce the total cost of production of the laminate while not sacrificing performance and physical properties of the laminate as compared to a monolithic aluminum foil material. Replacing aluminum foil in packaging processes and machines that use die-cut laminates, such as laminates for lidding, can be difficult. Plastics conventionally often may not have some desirable physical characteristics of aluminum foil, for example, the stiffness, lay-flat, and static charge dissipation characteristics of the foil material. Laminates of the present invention generally exhibit the same benefits of monolithic metal structures, e.g. strength, moisture barrier impermeability, ease of manipulation, capability of being embossed, sealing to other materials, while utilizing a reduced amount of metal as compared to conventional monolithic metal structures. Thus, laminates of the present invention can reduce the weight of aluminum needed and may have improved the puncture resistance as compared to conventional monolithic metal structures.

In certain embodiments, the laminates of the present invention may provide a laminate that is stiff enough to be die-cut. Further, once die-cut, the laminates can be generally well suited to use in packaging operations. For example, in certain embodiments, the laminate of the present invention can be stiff enough to be held by the edges of the laminate during dispensing in a packaging machine without bending or curling. Additionally, the laminates of the present invention generally can remain flat when exposed to heat either from the product to be packaged, such as a heated food product, e.g., hot-filled sauces, or from the heat that may emanate from a packaging machine itself, as when a container and laminate are positioned for heat sealing (i.e. cycled to an idle position beneath the heat sealing mechanism of the machine). Also, laminates of the present invention may facilitate denesting, as for example, when separating individual laminates from a stack of other laminates, due to the reduction in static charge and/or the increase of static dissipation by laminates of the present invention.

Some embodiments described herein can comprise a laminate structure having a reduced metal content that can be useful for packaging applications, such as heat sealable lids for food containers and the like. In some embodiments, the laminate structure can have enhanced performance characteristics over those reduced-foil products currently available. In such embodiments, the laminate is readily die-cuttable, sufficiently stiff, and has static charge dissipation characteristics such that the lidding structure can be die-cut in lid form, denested, and dispensed in a packaging apparatus.

Some embodiments described herein can comprise a reduced metal, die-cuttable laminate which can be heat sealable and/or peelable. In some embodiments, the laminate may be sealed to a container. In other embodiments, the laminate may be utilized to form a pouch. In some embodiments, the laminate may be sealed to another layer or structure such that the laminate may be peelably removed. For example, the laminate may comprise a film that is sealed to another structure. The structure may comprise a container such that the laminate functions as a lid.

In some embodiments, the lidding laminate can comprise a non-metal core layer. In some embodiments, the non-metal core layer can be substantially thicker than the outer layers. In some embodiments, the core layer can comprise a relatively thick void-bearing core film. The core layer can be positioned between a thinner, metal first outer layer and a thinner, metal second outer layer. The first outer layer and second outer layer can each be adhered to the core layer with a conventional flexible packaging adhesive.

In some embodiments, the thickness of the core layer may be between about 0.5 mil to about 10.0 mil. In some embodiments, the thickness of the core layer may be between about 1.0 mil to about 5.0 mil. In some embodiments, the core layer thickness may be between about 1.0 mil and about 3.0 mil. In some embodiments, the core layer thickness may be between about 1.2 mil and about 3.0 mil. In some embodiments, the core layer thickness may be about 1.2 mil.

In some embodiments, the non-metal core layer can comprise a polymer. In other embodiments, the non-metal core layer can comprise cellulose, such as paper. In yet other embodiments, the core layer can be comprised of a biopolymer, for example, cellophane or polylactic acid (available under NatureWorks® PLA by NatureWorks LLC).

In some embodiments, the non-metal core layer may comprise a voided polymer. As used herein, voided describes a polymer having cavitated or empty regions within the structure. In some embodiments, the non-metal layer may comprise an oriented polymer, for example a biaxially oriented polymer created by the stretching of the polymer in two different directions during formation. In some embodiments, the non-metal core layer may comprise polypropylene. In certain embodiments, the non-metal core layer may comprise a voided, oriented polypropylene. Other materials that may be suitable for use as the core layer can include a voided oriented polyester, foamed polystyrene, mineral filled un-oriented films, voided or foamed polyolefin films, or any combinations or mixtures thereof. Voided polymeric film or foamed film can utilize less total polymeric material that is needed for a given thickness of the film such that the film has a lower density. The voided polymeric film may also increase puncture resistance of the laminate material.

In some embodiments, a material for the core layer can be opaque. In certain embodiments, the opaque core layer can be voided. In certain embodiments, the core layer may comprise an oriented polymeric film. In some embodiments, the core layer can comprise a film of the type disclosed, for example, in U.S. Pat. No. 4,377,616 to Ashcraft et al.; U.S. Pat. No. 4,438,175 to Ashcraft et al.; or U.S. Pat. No. 4,770,931 to Pollock et al.

In some embodiments, the core layer, being comprised of voided oriented polypropylene, can have a yield between about 18,000 in²/lb to about 42,000 in²/lb. In other embodiments, the voided oriented polypropylene core layer can have a yield between about 19,500 in²/lb to about 42,000 in²/lb. In alternate embodiments, other polymers displaying similar yield ranges may be used.

In some embodiments, the core layer, being comprised of a cavitated film, for example voided oriented polypropylene, can have a density between about 0.4 g/cm³ to about 0.9 g/cm³. In some embodiments, the core layer can have a density between about 0.5 g/cm³ to about 0.8 g/cm³. In some embodiments, the core layer can have a density between about 0.5 g/cm³ to about 0.7 g/cm³. In some embodiments, the core layer can have a density between about 0.6 g/cm³ to about 0.7 g/cm³. In alternate embodiments, other polymers displaying similar density ranges may be used.

In some embodiments, the voided polymeric film can comprise protection from moisture ingress and/or egress. For example, in some embodiments, a biaxially oriented voided polypropylene core layer can maintain lid integrity as it is exposed to a high humidity environment or submersed in liquid. A biaxial oriented polymer may be used, for example, to reduce blistering of the laminate that may occur where the laminate is heat sealed.

In addition to reducing metal content of the laminate, the non-metal core layer can provide stiffness to the laminate that may be more beneficial in packaging operations. In some embodiments, the non-metal core layer can enhance the die-cuttability of the laminate. Alternatively or additionally, the voided core layer can reduce the weight of a film and/or density of a film, while continuing to have the desired properties of the monolithic foil lid or laminate. The core layer may also reduce the cost of production of the laminate. Additionally, as environmental considerations play an increased role in production costs, the laminate having a reduced metal content according to some embodiments described herein, may utilize less raw materials, generate less waste, and preserve a greater amount of natural resources.

In some embodiments, the laminate structure can comprise a first outer layer and a second outer layer. In some embodiments, the first outer layer and second outer layer can comprise a metal. In some embodiments, the first outer layer and second outer layer can comprise a metal foil. In certain embodiments, the first outer layer and second outer layer can comprise aluminum foil.

In some embodiments, the first outer layer and second outer layer can have substantially the same thickness. Thus the first outer layer and second outer can define a symmetrical or balanced construction. In some embodiments, the balanced first outer layer and second outer layer can provide a symmetrical structure to facilitate the laminate lying flat during various packaging operations and processes. In some embodiments, the first outer layer and second outer layer having substantially the same thickness can reduce curling. In other embodiments, the first outer layer and second outer layer having substantially the same thickness can prevent curling.

In other embodiments, the first outer layer and second outer layer can have substantially different thicknesses such that the first outer layer and the second outer layers are not substantially identical. In some embodiments, the difference in the thicknesses of the outer layers is such that the laminate structure is distinctly asymmetrical, but does not exhibit curling. In some embodiments, the asymmetrical or unbalanced layers can provide a lidding structure that can maintain the lidding material to lie flat. Such asymmetrical construction may be desirable to increase the mechanical properties of the particular outer layer. For example, it may be desired that an outer layer have a greater thickness to withstand forces that it may be subjected to during process or use.

In some embodiments, the first outer layer and the second outer may each have a thickness in a range of between about 0.20 mil (0.0002 inches) to about 1.0 mil (0.0010 inches). In other embodiments, the first outer layer and the second outer may each have a thickness in a range of between about 0.25 mil to about 1.0 mil. In other embodiments, the first outer layer and the second outer may each have a thickness in a range of between about 0.25 mil to about 0.75 mil. In further embodiments, the first outer layer and the second outer may each have a thickness in a range of between about 0.25 mil to about 0.5 mil. In yet further embodiments, the first outer layer and the second outer may each have a thickness in a range of between about 0.35 mil to about 0.5 mil.

In some embodiments, the first outer layer and second outer layer may be bonded to the core layer using various laminating techniques in the art. For example, the first outer layer and/or the second outer layer may be bonded using a two component polyurethane laminating adhesive. For extrusion lamination, the adhesive component may comprises an ethylene acrylic acid (EAA) grafter polymer or an EAA copolymer, an ethylene-methacrylic acid (EMAA) grafted polymer or an EMAA copolymer, or a maleic acid anhydride (MAA) grafter polymer or a MAA copolymer, as a layer between the outer layers and the core layer. In other embodiments, a dry bond or energy-curable adhesive may be used for adhering the outer layer to the core layer. Some examples of dry bond adhesives include polyurethane, acrylic, or polyester crosslinking polymers that are commercially available may be used. In other embodiments, adhesives that may be crosslinked by an electron beam or heat may also be employed.

In some embodiments, the laminate can comprise a sealing layer. The sealing layer may be applied to one of the outer layers. In some embodiments, an adhesive can be applied to adhere the sealing layer to the outer layer. The sealing layer can be applied to the side of the outer layer opposite to the side that contacts the core layer. In some embodiments, the sealing layer may function by heat sealing, pressure sealing, UV light activated sealing, or electron beam sealing. In some embodiments, the sealing layer can serve as a layer that adheres the laminate to a substrate. In some embodiments, the sealing layer can serve as a layer that adheres a lid that is die-cut from the laminate to a container. In some embodiments, the container is a polymeric container.

In some embodiments, the sealing layer comprises a heat seal layer. In some embodiments, a heat seal coating can be applied to the laminate structure. The heat sealant material can be chosen from a range of commercially available products, for example, EVA, vinyl-acrylic, polyester, ionomer, and polypropylene heat seal formulations which can be obtained from Rohm & Haas. The heat sealant material may be compatible with container to which laminate or lid would be adhered.

In other embodiments, the heat seal layer can serve as an adhesive for the laminate to create a pouch. In some embodiments, the pouch may be constructed by adhering one portion of the laminate structure to a separate portion of the same laminate structure. In other embodiments, a first laminate sheet and a second laminate sheet may be adhered together to create a pouch.

In some embodiments, one of the outer layers of the laminate of the present invention is heat sealable to a container material or to itself by applying thereto a heat seal coating, a hot melt adhesive, an extruded or co-extruded sealant polymer, or by laminating a heat seal film to such outer layer. In some embodiments, the heat seal layer may depend upon the material of the container to which the laminate lid is to be heat sealed. For example, if the container comprises polypropylene, a heat seal layer comprising ethylene vinyl acetate (EVA) or blends of EVA with other polymers compatible with polypropylene may be utilized. In other embodiments, the sealing layer may comprise specialty formulated EVA and EMA copolymers marketed as Appeel® by E. I. du Pont de Nemours and Company.

In embodiments having a sealing layer and/or printable layer, the laminate structure may be continued to be referred to as symmetrical or asymmetrical, exclusive of the presence of the sealing layer and/or printable layer. In other embodiments, the printing layer can be one of the outer layers. In some embodiments, printing can be directly applied on the outer layer.

In some embodiments, a laminate structure can be embossed. Embossing the laminate textures the surface to reduce the amount of surface contact between a plurality of laminate lidding materials or lids that are stacked together. When the lidding structures have a textured surface, they can be more easily denested.

In some embodiments, the present invention comprises a method for making a laminate having a reduced aluminum content, the method comprising adhering a first layer and a second layer to opposite sides of a core layer, and applying a sealing material to one of the first or second layers. A number of techniques to construct the laminate structure can be utilized, such as using an adhesive laminating process or extrusion laminating process. In some embodiments, the method can further comprise embossing the laminate to add surface texture to the outer layer opposite the sealing layer. In some embodiments, the surface texture created by the embossing step can facilitate the separation of a plurality of laminates.

Some embodiments described herein can comprise a laminate structure that reduces the amount of aluminum foil used in a laminate structure without significantly sacrificing any physical properties of the structure as compared to monolithic aluminum foil lidding material. Conventionally, the reduction of the amount of aluminum foil in a laminate can result in a loss of numerous mechanical properties and strength of the material; however, some embodiments as described herein can combine, for example, the moisture barrier properties of aluminum, the deadfold properties of aluminum, the benefit of the aluminum being easily embossed, and/or lack of static charge between the aluminum laminates (as compared to plastic) with the advantages of a non-aluminum core layer. Some of the advantages of having a core layer, particularly a cavitated film core layer (that is not comprised of aluminum), can include a reduction in the weight of aluminum used (and thereby a reduction in cost of aluminum materials) and improved puncture resistance when compared to a material comprising all aluminum. Further, the presence of a cavitated core layer reduces the laminate density thereby reducing the amount of materials that are needed to achieve a desired thickness.

In some embodiments, the laminate, systems, and methods of the present invention can reduce the amount of metal within the laminate by at least about 15% by weight as compared to a conventional monolithic metal foil, while maintaining the desired performance characteristics. In some embodiments, the laminate, systems, and methods of the present invention can reduce the amount of metal within the laminate by at least about 25% by weight, or by at least about 35% by weight, or by at least 50% by weight, or by at least 70% by weight as compared to a conventional monolithic metal foil, while maintaining the desired performance characteristics.

In some embodiments, the laminate, systems, and methods of the present invention can reduce the total thickness of metal (the first combined and second layer combined) within the laminate by at least about 15% as compared to a conventional monolithic metal foil, while maintaining the desired performance characteristics. In some embodiments, the laminate, systems, and methods of the present invention can reduce the total thickness of metal within the laminate by at least about 25%, or by at least about 35%, or by at least 50%, or by at least 70% as compared to a conventional monolithic metal foil, while maintaining the desired performance characteristics.

Further, from an environmental perspective, the reduced amount of aluminum in the laminate can produce less ash when incinerated as compared to a lidding material composed entirely of aluminum. The reduced amount of aluminum within a laminate further may require less raw materials to construct the laminate and thus providing a lidding material that demands less from the natural resources. A laminate structure of the present invention may reduce the amount of aluminum needed to construct a lidding material without significantly sacrificing the physical properties of a lidding material based solely on monolithic aluminum foil. A laminate structure according to embodiments described herein can have sufficient stiffness to be readily die-cuttable, can have excellent lay flat characteristics, can remain substantially curl-free when exposed to heat from either side, and/or can be readily denested from a stack of lids during package processing.

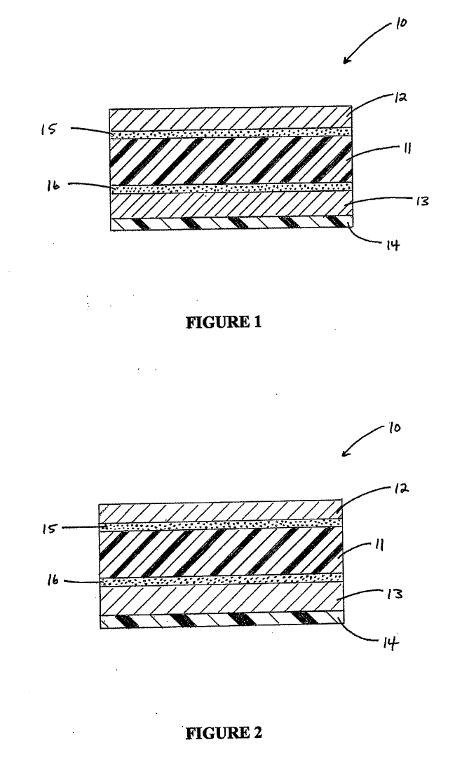

Referring now to the drawings, FIG. 1 shows a cross-section of a laminate structure made according to one illustrative embodiment. The laminate structure 10 comprises a core layer 11 made of a non-metal composition. In one embodiment, the non-metal core layer is a voided, polymeric film. In some embodiments, the core layer 11 comprises a voided polypropylene film. In one embodiment, the core layer 11 is a voided, oriented polypropylene film.

The laminate 10 may also comprise a first outer layer 12 bonded to one side of the core layer 11. In one embodiment, first outer layer 12 is bonded by an adhesive 15. A second outer layer 13 may also be bonded to the other side of the core layer 11 by an adhesive 16. The outer layers 12, 13 can be made of the same material. In some embodiments, the outer layers 12, 13 can comprise aluminum foil. The adhesive layers 15, 16 can comprise a thin layer of urethane or other suitable adhesive. A heat seal layer 14 may be laminated or applied to the second outer layer 13 for heat sealing the laminate 10 to a container.

The laminate structure 10 of FIG. 1 is constructed as a symmetrical or balanced film in that the structural and heat resistant components of the film, i.e., the outer layers 12, 13, have substantially the same thickness on opposite sides of the core layer 11. Such symmetrical construction can prevent or substantially reduce curling of even a very thin laminate 10 when the laminate is exposed to heat during the packaging operation.

FIG. 2 shows a cross-section of a laminate structure having an asymmetrical or unbalanced configuration. The laminate structure 10 may also comprise a first outer layer 12 bonded to one side of the core layer 11 by an adhesive 15. A second outer layer 13 may also be bonded to the other side of the core layer 11 by an adhesive 16. Outer layers 12, 13 can be made of the same material. In some embodiments, the outer layers 12, 13 can comprise aluminum foil. The adhesive layers 15, 16 can comprise a thin layer of urethane or other suitable adhesive. A heat seal layer 14 may be laminated or applied to the second outer layer 13 for heat sealing the laminate 10 to a container. In other embodiments, the heat seal layer 14 can be laminated or applied to the second outer layer 13.

As shown in FIG. 2, the outer layers 12, 13 may have different thickness on opposite sides of the core layer 11. For example, in the embodiment shown in FIG. 2, the second outer layer 13 has a thickness that is substantially greater than the first outer layer 12. Such asymmetrical construction can prevent or substantially reduce curling of the laminate 10 when it is exposed to heat during the packaging operation. Additionally, such asymmetrical construction may be desirable to increase the mechanical properties of the particular outer layer. For example, it may be desired that the second outer layer 13, having the heat seal layer 14 applied to it, having a greater thickness to withstand forces that it may be subjected to during process or use.

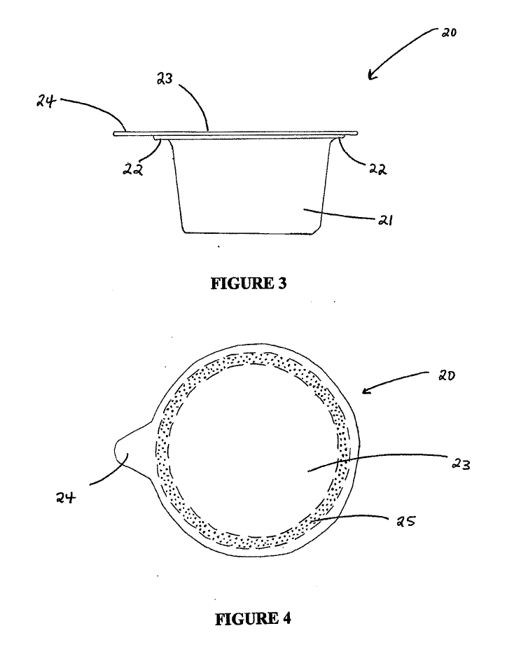

FIG. 3 depicts a container 20 comprising an open vessel, such as a cup 21 having an outturned lip portion 22 and a lid 23 with a pull tab 24. The lid 23 can be die-cut from a laminate of the present invention such as the laminate 10 shown in FIG. 1. After the cup 21 is filled with material, e.g., a food product, the lid 23 can be dispensed from a stack of lids and positioned by a packaging machine on the lip portion 22 of the cup 21. The heat seal mechanism or head of a packaging machine can then contact the lid 23 in the region of the lip 22 and, by a combination of heat and pressure applied in a conventional manner, the lid 23 can be heat sealed to the lip 22 of the cup 21.

FIG. 4 shows a top plan view of a lid 23 which has a generally circular shape with a pull tab 24 extending radially therefrom. The annular stippled area 25 shows the area to which heat is applied in the packaging machine to form a heat seal between the lid 23 and the lip 22 of the cup 21.

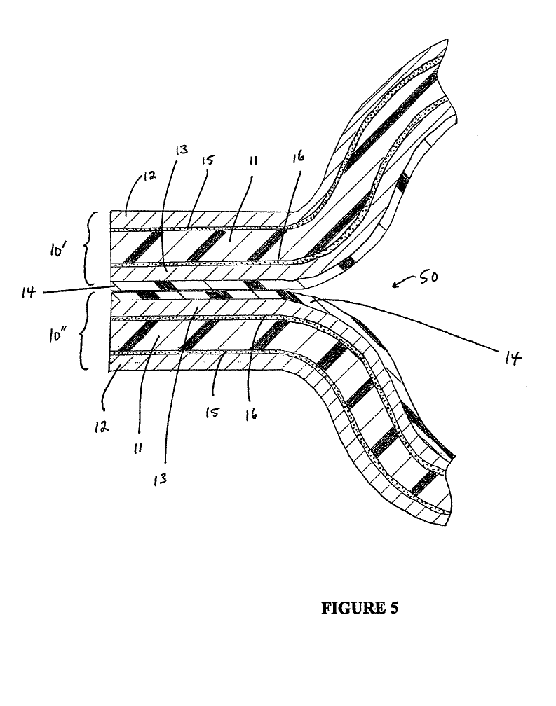

FIG. 5 shows a cross-sectional view of a laminate structure 10′ heat sealed to itself of a second laminate 10″ to form a pouch 50. The laminate 10′ comprises a first outer layer 12 bonded to one side of a core layer 11 by an adhesive 15. A second outer layer 13 is bonded to the other side of the core layer 11 by an adhesive 16. The adhesive layers 15, 16 can comprise a thin layer of urethane or other suitable adhesive. A heat seal layer 14 is laminated or applied to the second outer layer 13 for heat sealing the laminate 10′ to a second laminate 10″. The second laminate 10″ may also comprise a first outer layer 12 bonded to one side of a core layer 11 by an adhesive 15. A second outer layer 13 is bonded to the other side of the core layer 11 by an adhesive 16. The two laminates, being heat sealed to each other define the pouch 50. In some embodiments, the laminate 10′ and the laminate 10 ″ can be the same laminate structure, for example, that may be folded upon itself. In other embodiments, laminates of the present invention can be sealed to another type of laminate (in some cases also a reduced foil laminate) to form a pouch.

### EXAMPLES 1-6

Laminate structures according to some embodiments described herein were prepared having the following construction:

For Samples 1-4, the core layer corresponding to layer 11 of FIG. 1 was a commercially available product that was a 1.2 mil void-bearing opalescent oriented polypropylene film having a yield of 35,000 in² /lb. To each side of the core layer a aluminum metal layer was bonded to the core layer using commercially available laminate adhesives. The thicknesses of the outer layers of Samples 1-4 were different for each sample (as seen in Table 1). Samples 1 and 2 are symmetrically structured foil lidding laminates. Samples 3 and 4 are asymmetrically structured foil lidding laminates.

For Sample 5, the core layer corresponding to layer 11 of FIG. 1 was a commercially available product that was a 2.2 mil paper material. To each side of the paper core layer, a 0.25 mil aluminum layer was bonded.

For Sample 6, a 1.5 mil foil structure was tested.

Tables 1-3 below outline the specifications of the samples that were tested.

TABLE 1
Sample Specifications

| | Outer layer | Core layer | Outer layer | | | |
|---|---|---|---|---|---|---|
| | thickness-- | thickness | thickness-- | Total | Basis | |
| Sample | aluminum | (polypropylene) | aluminum | thickness | weight | Yield |
| No. | (mil) | (mil) | (mil) | (mil) | (lb/30000 ft²) | (in²/lb) |
| 1 | 0.35 | 1.2 | 0.35 | 1.88 | 43.9 | 9847 |
| 2 | 0.50 | 1.2 | 0.50 | 2.23 | 57.7 | 7487 |
| 3 | 0.35 | 1.2 | 0.50 | 2.07 | 50.4 | 8566 |
| 4 | 0.50 | 1.2 | 0.35 | 2.08 | 50.4 | 8566 |

TABLE 2
Sample Specifications

| | Outer | | Outer | | | |
|---|---|---|---|---|---|---|
| | layer | Core | layer | | | |
| | thick- | layer | thick- | | Basis | |
| | ness-- | thick- | ness-- | Total | weight | |
| Sam- | alumi- | ness | alumi- | thick- | (lb/ | |
| ple | num | (paper) | num | ness | 30000 | Yield |
| No. | (mil) | (mil) | (mil) | (mil) | ft²) | (in²/lb) |
| 5 | 0.25 | 2.2 | 0.25 | 2.7 | 50.2 | 8600 |

TABLE 3
Sample Specifications

| | Thickness 1.5 mil | Basis weight | |
|---|---|---|---|
| Sample No. | foil | (lb/30000 ft²) | Yield (in²/lb) |
| 6 | 1.56 | 64.4 | 6705 |

The samples underwent various tests to determine the physical properties of the laminate. The samples were tested using the Mullen Burst Test to measure the burst strength of the lidding materials. The Mullen Burst Test was conducted in accordance with industry standards and procedures. The samples were tested for puncture resistance related properties using testing devices provided by Instron in accordance industry standards and procedures. Additionally the samples were tested to determine the tearing resistance of the material using the Elmendorf test. The Elmendorf test determines the average force in grams required to tear a single sheet of the laminate after the tear has been started. Also the density of each laminate was determined.

Table 4 depicts the results of the various tests.

TABLE 4
Test Results

| | | Punc- | | | | |
|---|---|---|---|---|---|---|
| | | ture | | | | |
| Sam- | Mullen | (lbs) | Puncture | Elmendorf | Elmendorf | Laminate |
| ple | Burst | Instron | (lbs) | tear MD | Tear CD | Density |
| No. | (psi) | #1 | Instron #4 | (g) | (g) | (g/cm³) |
| 1 | 32.3 | 1.92 | 3.43 | 42.7 | 41.3 | 1.50 |
| 2 | 38.0 | 2.18 | 4.21 | 65.3 | 61.3 | 1.66 |
| 3 | 35.3 | 2.04 | 6.5 | 50.7 | 56 | 1.56 |
| 4 | 35.0 | 2.03 | 6.1 | 56 | 52 | 1.55 |
| 5 | 33.3 | 2.03 | 3.01 | 62.7 | 77.3 | 1.19 |
| 6 | 19.7 | 1.26 | 2.14 | 64 | 69.3 | 2.65 |

It can be seen that samples having a reduced amount of metal content as compared to a monolithic foil structure can have a greater burst strength, a greater puncture resistance, and lower total density.

The laminate structures produced as described above were free of curl before die cutting. After die cutting, the die-cut lids laid flat and had no curl in either direction at room temperature. When exposed to 200 degree Fahrenheit heat, the lids remained flat and did not exhibit any noticeable curl.

In some embodiments, the laminate constructed according to the description herein can have a burst strength greater than the burst strength of a monolithic foil structure. In some embodiments, the laminate can have at least about 20% greater burst strength than a monolithic foil structure burst strength. In some embodiments, the laminate can have at least about 40% greater burst strength, at least about 60% greater burst strength, at least about 80% greater burst strength, or at least about 90% greater burst strength than a monolithic foil structure burst strength.

In some embodiments, the laminate constructed according to the description herein can have a puncture resistance greater than the puncture resistance of a monolithic foil structure. In some embodiments, the laminate can have at least about 20% greater puncture resistance than a monolithic foil structure puncture resistance. In some embodiments, the laminate can have at least about 35% greater puncture resistance strength, at least about 50% greater puncture resistance, at least about 65% greater puncture resistance strength, or at least about 80% greater puncture resistance than a monolithic foil structure burst strength.

In some embodiments, the laminate constructed according to the description herein can have a density less than the density of a monolithic foil structure. In some embodiments, the laminate can have a density at least about 20% less than the density of a monolithic foil structure. In some embodiments, the laminate can have at least about 30% less than the density of a monolithic foil structure, at least about 40% less than the density of a monolithic foil structure, at least about 50% less than the density of a monolithic foil structure, or at least about 60% less than the density of a monolithic foil structure.

Although certain embodiments have been described herein, it will be apparent to those skilled in the art to which the description pertains that variations and modifications of the described embodiments may be made without departing from the spirit and scope of the disclosure. Accordingly, the description herein should not be read as limiting such embodiments, as other embodiments also fall within the scope of this disclosure.

What is claimed is:

1. A laminate comprising:
a non-metal core layer;
a first outer layer comprising a metal; and
a second outer layer comprising a metal;
wherein the first outer layer and the second outer layer are laminated on opposite sides of the core layer.

2. The laminate of claim 1, wherein the first outer layer comprises a metal foil.

3. The laminate of claim 1, wherein the first outer layer comprises aluminum foil.

4. The laminate of claim 1, wherein the second outer layer comprises a metal foil.

5. The laminate of claim 1, wherein the second outer layer comprises aluminum foil.

6. The laminate of claim 1, wherein the core layer comprises a thickness in a range of about 0.5 mils to about 10.0 mils.

7. The laminate of claim 1, wherein the first outer metal layer comprises a thickness in a range of about 0.20 mils to about 1.0 mils.

8. The laminate of claim 1, wherein the second outer metal layer comprises a thickness in a range of about 0.20 mils to about 1.0 mils.

9. The laminate of claim 1, wherein the first outer layer and the second outer layer have substantially the same thickness.

10. The laminate of claim 1, wherein the first outer layer and the second outer layer have a substantially different thickness.

11. The laminate of claim 1, further comprising a sealing layer applied to one of the outer layers.

12. The laminate of claim 1, wherein the core layer comprises a void-bearing, opalescent, oriented polypropylene film.

13. The laminate of claim 12, wherein the polypropylene core layer has a density in a range between about 0.4 g/cm³ to about 0.9 g/cm³.

14. The laminate of claim 1, wherein the core layer comprises a cellulosic material.

15. The laminate of claim 1, wherein the first outer layer and the second outer layer each comprise a thickness to reduce curling of the laminate.

16. The laminate of claim 1, wherein at least one of the first outer layer or second outer layer is embossed such that surface texture is applied to the outer layer to facilitate separation of a plurality of laminates.

17. The laminate of claim 1, wherein the laminate is die-cuttable.

18. The laminate of claim 1, wherein the laminate is sealable to itself such that a pouch is defined.

19. A system comprising:
a laminate comprising a non-metal core layer; a first outer metal layer, and a second outer metal layer, the first outer metal layer and second outer metal layer being laminated on opposite sides of the core layer; and
a container; and
wherein the laminate is sealable to the container.

20. The system of claim 19, wherein the core layer comprises a thickness in a range of about 0.5 mils to about 10.0 mils.

21. The system of claim 19, wherein the first outer metal layer comprises a thickness in a range of about 0.20 mils to about 1.0 mils.

22. The system of claim 19, wherein the second outer metal layer comprises a thickness in a range of about 0.20 mils to about 1.0 mils.

23. The system of claim 19, wherein the laminate is die-cuttable into a lid such that the lid can be sealed to the container.

24. The system of claim 19, wherein the laminate further comprises a sealable layer.

25. A method for making a laminate comprising:
adhering a first layer and a second layer, each comprising a metal, to the opposite sides of a non-metal core layer to form a laminate comprising a non-metal core layer, a first outer metal layer, and a second outer metal layer; and
applying a sealing layer to the exterior of one of the outer layers.

26. The method of claim 25, further comprising embossing the laminate wherein the embossing adds surface texture to the outer layer opposite the sealing layer to facilitate the separation of a plurality of laminates.
